(19) United States
(12) Patent Application Publication
(10) Pub. No.: US 2026/0341744 A1
(43) Pub. Date: Oct. 29, 2026

(54) COMBINED USE OF INTERPENETRATING AND LAMINATED ELECTRODES FOR LI-ION AND NA-ION BATTERIES

(71) Applicant: Prieto Battery, Inc., Fort Collins, CO (US)

(72) Inventors: Amanda R. Mohrlang, Fort Collins, CO (US); Adam D. Miller, Fort Collins, CO (US); Travis C. Varra, Fort Collins, CO (US); Kai Z. Fuller, Longmont, CO (US)

(73) Assignee: Prieto Battery, Inc., Fort Collins, CO (US)

(21) Appl. No.: 19/660,175

(22) Filed: Apr. 27, 2026

Related U.S. Application Data
(60) Provisional application No. 63/795,139, filed on Apr. 25, 2025.

(51) Int. Cl. H01M 4/80; H01M 4/02; H01M 4/133; H01M 4/136; H01M 4/66; H01M 10/0525; H01M 10/054

(52) U.S. Cl. CPC H01M 4/80; H01M 4/133; H01M 4/136; H01M 4/661; H01M 10/0525; H01M 10/054; H01M 2004/021; H01M 2004/028

(57) ABSTRACT

A Li-Ion or Na-Ion battery, comprising: a 3-dimensional porous anode current collector having an intermetallic composition or tin electrodeposited thereon for reversibly alloying lithium ions or sodium ions, and a lithium-ion or sodium ion, conducting, electrically insulating, gelled polymer electrolyte covering the intermetallic or tin; a first cathode material deposited on the electrolyte interpenetrating the porous spaces of the 3-dimensional porous anode current collector, forming a 3-dimensional flat structure having a first surface and an opposing second surface; a first electrically conductive layer in electrical communication with the first cathode material and covering the first surface; a second electrically conductive layer in electrical communication with the first cathode material and covering the second surface; a first layer of second cathode material coated onto a first metal current collector and in electrical contact with the first electrically conductive layer; and a second layer of second cathode material coated onto a second metal current collector and in electrical contact with the second electrically conductive layer, is described.

### CROSS-REFERENCE TO RELATED APPLICATIONS

The present application claims the benefit of U.S. Provisional Patent Application No. 63/795,139 for “COMBINED USE OF INTERPENETRATING AND LAMINATED ELECTRODES FOR LI-ION AND NA-ION BATTERIES”, which was filed on 25 Apr. 2025, the entire content of which patent application is hereby specifically incorporated by reference herein for all that it discloses and teaches.

### BACKGROUND

Solid-state lithium-ion batteries (LIB), and sodium-ion batteries (NIB) that use the same working principle as LIBs but utilize earth-abundant, low-cost sodium compounds instead of lithium compounds, are considered a safe alternative to conventional non-aqueous electrolyte based batteries. However, there are two principal issues that must be addressed before such solid-state batteries become widely commercially accepted. The first is the slow diffusion of cations into the anode and the cathode, as well as slow diffusion within the solid-state electrolyte separating the two electrodes, which causes the charge/discharge rates of such batteries to be inferior to conventional batteries. The second is that solid-state Li-ion batteries generally include thin layers to compensate for the slow solid-state diffusion, but at the expense of energy density.

While reducing the dimensions of the electrode materials improves the rate performance compared to bulk materials, reducing the distance between the cathode and anode cell structures has not been straightforward, and cations are required to travel large distances between macroscopically separated electrodes. Planar geometries of batteries resulting from commonly used line-of-sight fabrication techniques significantly reduces the energy density that can be obtained.

U.S. Pat. No. 10,290,876 for “Lithium-Ion Battery Having Interpenetrating Electrodes”, by Prieto et al. describes a lithium-ion battery including: a three-dimensional conducting porous foam current collector having an intermetallic material thereon, forming thereby a porous anode; a solid-state electrolyte conformally coated onto the anode for providing high resistance to electrical current and little resistance to the passage of lithium ions; and cathode material filling the pores of the coated anode, which permits short Li-ion diffusion times within the electrode materials and between them, while maintaining useful energy densities.

### SUMMARY

In accordance with the purposes of embodiments of the present invention, as embodied and broadly described herein, an embodiment of the Li-Ion or Na-Ion battery, hereof includes: a 3-dimensional porous anode current collector having an intermetallic composition or tin electrodeposited thereon for reversibly alloying lithium ions or sodium ions, and a lithium-ion or sodium ion, conducting, electrically insulating, gelled polymer electrolyte covering the intermetallic or tin; a first cathode material deposited on the electrolyte interpenetrating the porous spaces of the 3-dimensional porous anode current collector, forming a 3-dimensional flat structure having a first surface and an opposing second surface; a first electrically conductive layer in electrical communication with the first cathode material and covering the first surface; a second electrically conductive layer in electrical communication with the first cathode material and covering the second surface; a first layer of second cathode material coated onto a first metal current collector and in electrical contact with the first electrically conductive layer; and a second layer of second cathode material coated onto a second metal current collector and in electrical contact with the second electrically conductive layer.

Benefits and advantages of the present invention include, but are not limited to, providing a Li-Ion or Na-Ion battery structure having improved energy density.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a schematic representation of the cross section of a Li-Ion or Na-Ion battery showing intermetallic material porous foam is placed in electrical communication with a metallic lead, and is covered with an electropolymerized solid-state layer of electrolyte, a cathode slurry is cast into the void space of the porous foam and placed in electrical communication with a second electrode, electrically isolated from the anode structure by the electrolyte layer.

FIG. 2 is a schematic representation of the cross section of a Li-Ion or Na-Ion battery showing intermetallic material porous foam placed in electrical communication with a metallic lead, and is covered with an electropolymerized layer of electrolyte, with a first cathode slurry cast into the void space of the porous foam and placed in electrical communication with a second electrode, electrically isolated from the anode structure by the electrolyte layer, and showing additional planar cathode structures that improve the energy density of the battery in accordance with the teachings of embodiments of the present invention.

### DETAILED DESCRIPTION

As set forth above, Li-Ion batteries having interpenetrating electrodes are known in the art.

Briefly, embodiments of the present invention include a Li-Ion or Na-Ion battery including a 3-dimensional porous anode current collector having an intermetallic composition or tin electrodeposited thereon for reversibly alloying lithium ions or sodium ions, and a lithium-ion or sodium-ion, conducting, electrically insulating, gelled polymer electrolyte covering the intermetallic or tin; a first cathode material deposited on the electrolyte interpenetrating the porous spaces of the 3-dimensional porous anode current collector, forming a 3-dimensional flat structure having a first surface and an opposing second surface; a first electrically conductive layer in electrical communication with the first cathode material and covering the first surface; a second electrically conductive layer in electrical communication with the first cathode material and covering the second surface; a first layer of second cathode material coated onto a first metal current collector and in electrical contact with the first electrically conductive layer; and a second layer of second cathode material coated onto a second metal current collector and in electrical contact with the second electrically conductive layer.

Reference will now be made in detail to the present embodiments of the invention, examples of which are illustrated in the accompanying drawings. It will be understood that the FIGURES are presented for the purpose of describing particular embodiments of the invention and are not intended to limit the invention thereto. Similar or identical structure is labeled with identical numbers.

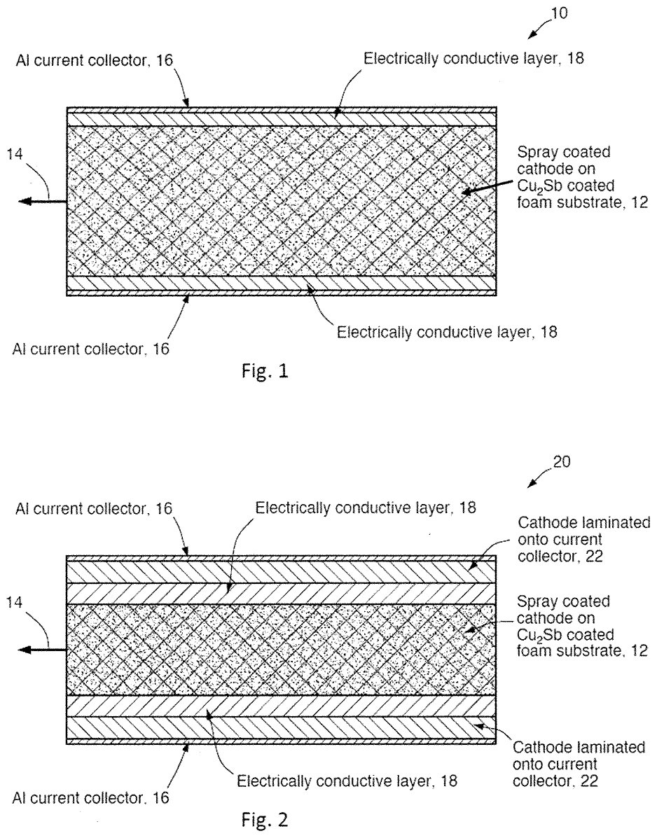

FIG. 1 is a schematic representation of the cross section of a Li-Ion or Na-Ion battery, 10, showing intermetallic material porous foam, 12, is placed in electrical communication with a metallic lead, 14, and is covered with an electropolymerized solid-state layer of electrolyte, a cathode slurry being cast into the void space of the porous foam and placed in electrical communication with a second electrode, electrically isolated from the anode structure by the solid-state electrolyte layer. The second battery current collector, 16, which may be aluminum foil, is placed in electrical contact with the cathode material through an electrically conductive layer, 18, containing carbon nanotubes or conductive graphite.

FIG. 2 is a schematic representation of the cross section of an improved Li-Ion or Na-Ion battery, 20, in accordance with the teachings of embodiments of the present invention, showing intermetallic material porous foam 12 placed in electrical communication with metallic lead 14, and is covered with a conformal coating of polymer by electrophoretic deposition, a first cathode slurry is cast into the void space of the porous foam and placed in electrical communication with planar second cathode structures, 22, through electrically conductive layer, 18, containing carbon nanotubes or conductive graphite. Planar second cathode structures, 22 are placed in electrical communication with current collector 16, which may be aluminum foil. The additional planar cathode structures, 22, improve the energy density of the battery.

### A. Generation of the Li-Ion Battery:

### Spray Slurry Prep

The following procedure is to make a first cathode slurry that has a weight solids percentage of 55.27%, where 87.5% of the solids is: LiNi_{0.8}Co_{0.1}Mn_{0.1}O₂ (NMC811), 3.5% polyvinylidene difluoride (PVDF), 4.0% C65, a conductive carbon black additive, and 5% KS6L, a conductive graphite powder. 107.35 g of N,N-dimethylformamide (DMF) and 141 g of 2-butanone (MEK) are weighed (XS8001S, Mettler Toledo, Ohio, United States) into a 625 mL polypropylene mixing cup. 10.800 g of PVDF and 1.389 g of BYK-9077 are weighed (FX-200i, A&D Weighing, Michigan, United States) and then placed into the solvent cup. This was then mixed (DAC 800.1 FVZ, Hauschild SpeedMixer, Michigan, United States) for 10 min. at 1750 rpm. After mixing, 12.342 g of C65 and 15.429 g of KS6L were weighed and then placed into the cup. This was again mixed for 10 min. at 1750 rpm. This slurry cup was then placed into an ice bath and a sonicator with ½″ solid horn (Q500, QSonica, Connecticut, United States) was used to sonicate the slurry for 30 min. at 90% amplitude with a 10 s ON/OFF cycle. The lithium nickel manganese cobalt oxide, LiNi_{0.8}Co_{0.1}Mn_{0.1}O₂, NMC 811 (MSE PRO, MSE Supplies, Tuscan Arizona, United States) was weighed inside of an Ar filled glovebox (Omni-Lab, California, United States). The NMC 811 was then brought out of the glovebox and placed into the carbon slurry where it was mixed for 10 min. at 800 rpm. The slurry was finally divided into 3 smaller planetary mixing cups until used.

### Spray Procedure

Unless otherwise specified, procedures were performed at 25 °C. Strapping tape (200 m×10 mm×0.03 mm, MTI, Richmond, California, United States) is placed over the top of the cell to cover the masked area of the foam. The pre cathode weight of the cell is then measured. A ⅛″ thick sheet of Delrin (McMaster-Carr, Santa Fe Springs California, United States) was laser cut (Fusion Pro, Epilog, Golden, Colorado, United States) into a 15×11 cm piece with two 12.25 cm² squares cut out of it. The cell was placed under this piece of cut Delrin before and during the spray deposition, with only the active anode material being exposed through the two cut squares. The spray atomizer (VX-70, Spraying Systems, Illinois, United States) with compressed air for the atomizer (10 psi) and fan (7.5 psi), compressed nitrogen for raising the atomizer pin (75 psi), and the spray nozzle placed 6 in. above the cells that will be sprayed. The cathode slurry was mixed in the planetary mixer (Mazerustar KK-250S, Kurabo, Tokyo, Japan) set to a revolution setting of 7 and a rotation setting of 8 for 15 min. A magnetic stir bar was placed in the slurry and the slurry cup was placed on a stir plate (RT Basic Series Magnetic Stirrers, ThermoFisher Scientific, Waltham, Massachusetts, United States) that was set to 500 rpm. The slurry cup's lid was removed and a circular piece of ⅛″ Delrin with two 6 mm diameter holes was placed on top and fastened with rubber bands. Two pieces of tubing (Masterflex L/S® Precision Pump Tubing, Versilon™ 2001 Tubing, L/S 16, Avantor Sciences, Radnor, Pennsylvania, United States) were then fed into the slurry cup, with one going through the peristaltic pump (Masterflex L/S 07528-10, Avantor Sciences, Radnor, Pennsylvania, United States) before being attached to the sprayer inlet and the other going directly to the sprayer outlet. The pump was set to 25 rpm and the slurry was pumped through the sprayer. Once cathode has cycled through the entire system, the Delrin masked cells are placed underneath the sprayer and enough cathode material is deposited on the cell to achieve 25% of the anode capacity. The Delrin mask is then removed and the cells are dried at 80 °C for 30 min. inside of a vacuum oven (VWR 1493, Avantor Sciences, Radnor, Pennsylvania, United States). The cells are then flipped upside down and placed back underneath the Delrin mask so the other side is exposed to be sprayed with cathode. The Delrin masked cells are then placed underneath the sprayer and the rest of the cathode material needed to match 25% of the anode capacity was deposited. This process is repeated until the desired cathode matching is achieved. The cells are then dried at 80 °C for 30 min.

### B. Electrophoretic Solid-Polymer-Electrolyte Deposition Procedure for Both Li-Ion and Na-Ion Batteries:

Using the laser cutter (Fusion Pro 17000 Epilog Laser Golden CO United States), cut out individual anodes to desired footprint size. Using a sonic welder (MW20SC Sonics Newtown CT United States), attach 4 mm wide nickel tab (PLiB-NTA4 MTI Richmond CA United States) to the top masked area of anode, approximately 1 cm from left edge. Using a calendaring machine (FM-JS250 Felix Machines Beaverton OR United States) run the tabbed anode through until 350 μm thick. Confirm thickness with digital thickness gage (Mitutoyo Absolute Model 6066 Chicago IL United States), measuring the bottom middle and top of the anode for an average pre deposition thickness. Once anodes are calendared to 350 μm, obtain pre-deposition weights using a balance (Mettler Toledo XSR104 Columbus OH United States).

Prepare the solid polymer electrolyte (SPE) Bayhydrol XP 2637 solution. In an empty beaker, measure 40 mL of Bayhydrol XP 2637 40 wt. % solids (Covestro Deutschland AG Leverkusen Germany). Place the beaker on stir plate and add stir bar. Turn on stirring to 600 rpm. Via 1 ml syringe, add 0.185 mL of Cymel 385 resin crosslinker (Allnex Frankfort Germany) dropwise. Cover with parafilm and stir mixture for 20 minutes. Then dilute the solution to the desired 20 wt. % solids by adding 40 mL of DI water. Continue to stir for an additional 20 min.

Bayhydrol 2637, from Covestro Deutschland AG, a commercial version of a waterborne polyurethane dispersion, is comprised primarily of the following components: Hydroxy-terminated polycarbonate; hydrogenated methylene diphenyl diisocyanate (HMDI); DMPA ionomer; and a triethylamine (TEA) neutralized dimethylolpropionic acid (DMPA), and. as provided, is 40% solids in water.

Cymel, from Allnex, Frankfort, Germany, crosslinkers are a family of melamine-formaldehyde resins commonly used as thermosetting agents to enhance the mechanical strength, chemical resistance, and thermal stability of polymer coatings. These materials are based on melamine (1,3,5-triazine-2,4,6-triamine), which contain multiple amine functionalities that react with formaldehyde to form highly functionalized methylol or alkoxymethyl derivatives capable of further condensation reactions. In polymer systems, Cymel crosslinkers react with functional groups such as hydroxyl, carboxyl, amine, or amide groups present in the polymer backbone, forming a densely crosslinked network upon curing.

Begin the pre-electrophoretic deposition (EPD) anode cleaning process. In a 200 ml beaker fill with 175 mL of 2-propanol (GFS Chemicals Inc. Columbus OH United States). Bend the nickel tabs of the anodes so that they can hang on the edge of the beakers while keeping the anode submerged in the 2-propanol. Add stir bar and place on stir plate. Set to 300 rpm and let stir for 2 minutes. Remove anodes from the 2-propanol and hang/submerge in another 200 ml beaker filled with 175 mL of DI water (Purelab Chorus Elga Veolia Paris France). Place on second stir plate and stir at 300 rpm for 2 minutes. Set up a third 200 ml beaker with 175 mL of 1% by volume HCl (Thermo Fisher Scientific Waltham MA, United States) and place on original stir plate. Remove the anodes from the DI water and spray rinse them with DI water to remove any residual 2-propanol. Once thoroughly rinsed submerge in the HCl. Stir at 300 rpm for 2 minutes. Replace the water in the DI beaker with 175 mL of fresh DI water. Transfer the anodes from HCl solution to DI water and stir again for 2 minutes. Repeat the anode DI water rinsing step to remove residual HCl. Place anodes in a fourth beaker filled with 175 mL of methanol (Sigma-Aldrich St. Louis MO United States). Place beaker in a sonicator and let sonicate for 5 min.

Start the EPD procedure. Turn on power supply (Keysight Technologies Loveland CO United States) and allow it to connect to the Labview software (National Instruments Austin TX United States). In the software interface, set voltage to +150V, current to 0.825 A, and pulse time to 3 s. Insert the stainless-steel counter electrodes into the deposition chamber. Connect the counter electrodes and sense wire to the power supply. Fill deposition holder to the top of the counters with the 20 wt % by volume Bayhydrol 2637 solution. Remove the anode from the MeOH and straighten the Ni tab. Clamp the Ni tab in the alligator clamp connected to the positive terminal and center above the chamber. Lower the sample into the solution, rising it back out of solution and lowering it back in three times. Make sure the sample is centered between the two counter electrodes and then run the first deposition. The first two depositions are galvanostatic holding the current constant at 825 mA (first deposition) and 700 mA (second deposition). Followed by repeating constant voltage depositions at 30 V. Repeat potentiostatic depositions until the current reaches zero, drying anodes between each deposition at 80 °C for 15 min. Desired loading is 20-25 mg/cm².

After each deposition, wick rinse to remove excess water and then clamp on drying rack. Place in vacuum oven (VWR 1493 Avantor Sciences Radnor PA United States) pre-heated to 80 °C. Open the vent and pull vacuum for convection drying for 10 minutes. Close vent and pull vacuum for an additional 5 min. Remove rack from oven and start the next deposition. Once all depositions are complete, place in vacuum oven for 10 min. of convection drying. Turn the temperature up to 120 °C and pull full vacuum overnight.

### C. Laminate Slurry Preparation for Li-Ion Batteries:

The following procedure is to make a second cathode slurry that has a weight solids percentage of 51.23%, where 97.6% of the solids is NMC811, 2.0% Polyvinylidene Difluoride (PVDF), 0.4% Single-Walled Carbon Nanotubes (SWCNT). NMC811 and single-wall carbon-nanotube dispersion in NMP (Tuball™ Batt NMP), 0.4% (Shanghai Haiyi Scientific & Trading Co., Shanghai, China) was placed into a planetary mixing cup and then mixed in the planetary mixer (Mazerustar KK-250S, Kurabo, Tokyo, Japan) set to a revolution setting of 7 and a rotation setting of 8 for 15 min.

### Laminate Procedure

A sheet of aluminum foil for battery cathode substrate (350 m×280 mm×15 μm, MTI, Richmond, California, United States) was cut into a 95 mm×280 mm piece that was then placed onto a automatic film applicator (TQC Sheen 1133N, Industrial Physics, Hadley, Massachusetts, United States). A square applicator (Square Frame 4″, 5-50 mils, BYK, Chester, New York, United States) was placed over the foil with 20 mil side placed on the bottom and closest to the film applicator arm. Laminate slurry was pipetted onto the foil inside of the square applicator. The film applicator was then used to push the square applicator along the aluminum foil to create a 20 mil layer of cathode slurry. The cathode foils were then dried overnight at 120 °C under vacuum. The cathode foils were placed into a laser cutter (Fusion Pro, Epilog, Golden Colorado, United States) where they we cut to match the shape of the foam cells (31 mm×31 mm) with a 13 mm×6 mm tab off one of the corners. Half of the cuts were made with the tab on the left side and half with the tab on the right. The tabs of the cathode laminates were then gently scraped to remove the cathode slurry and then cleaned by wiping with a Kimwipe and isopropanol. The cut laminates were weighed to determine the cathode capacity and then calendared (FM-JS250, Felix Machines, Beaverton Oregon, United States) to achieve a 30% porosity. Tuball™ Batt NMP was screen printed onto the cut laminates using an 8″×10″ stainless steel 80 mesh screen with a wire diameter of 0.0037″ (Metal Etch Service, Inc., San Marcos, California) the laminates were then adhered to both sides of the cathode sprayed anode foams, so that the laminate tabs were aligned opposite the nickel tab. These were dried under a steel plate (¼″×4″×6″) overnight at 120 °C under vacuum.

### Packaging

A 4 mm aluminum tab (PLiB-ATC4, MTI, Richmond California, United States) was placed onto the cathode laminate tab and its sealing tape was lined up with the sealing tape of the 4 mm nickel tab (PLiB-NTA4, MTI, Richmond California, United States) of the copper foam substrate. The aluminum tab was then welded (MW20, Sonics, Newtown Connecticut, United States) onto the aluminum current collector of the cell. The cell was then placed in between two 3×2.5″ sheets of aluminum laminated film (ALF48020, MTI, Richmond California, United States) where it was then heat sealed (MSK-140, MTI, Richmond California, United States) along three sides of the packaging starting with the tabbed side. The packaged cell was then brought into an Ar filled glovebox (Omni-Lab 110V, VAC, Hawthorne California, United States) and 2 mL of electrolyte (3:7 EC:EMC (vol:vol), 1M LiPF₆, 5 wt % FEC (w.r.t. solvent)) was added. The packaged cells were placed inside of a diffuser chamber (MSK-170, MTI, Richmond California, United States). Finally, packaged cells were vacuum heat sealed with a heater sealer (MSK-115A, MTI, Richmond California, United States) and then brought out of the glovebox.

### D. Generation of the Na-Ion Battery:

### Spray Slurry Preparation:

The following procedure is to make a cathode slurry that has a weight solids percentage of 41.86%, where 87.5% of the solids is NaNi_{1/3}Fe_{1/3}Mn_{1/3}O₂, 3.5% polyvinylidene difluoride (PVDF), 4.0% C65, and 5% KS6L. 62.07 g of N,N-dimethylformamide (DMF) and 81.53 g of 2-butanone (MEK) are weighed (XS8001S, Mettler Toledo, Ohio, United States) into a planetary mixing cup. 3.62 g of PVDF and 0.47 g of a solvent-free wetting and dispersing additive for solvent-borne and solvent-free coatings (BYK-9077), are weighed (FX-200i, A&D Weighing, Michigan, United States) and then placed into the solvent cup. This was then mixed in a planetary (Mazerustar KK-250S, Kurabo, Tokyo, Japan) set to a revolution setting of 7 and a rotation setting of 8 for 15 minutes. After the mixing, 4.14 g of C65 and 5.17 g of KS6L are weighed and then placed into the cup. This was again mixed with the same settings. This slurry cup was then placed into an ice bath and a sonicator with ½″ solid horn (Q500, QSonica, Connecticut, United States) was used to sonicate the slurry for 30 minutes at 90% amplitude with a 10 second ON/OFF cycle. 90 g of the sodium nickel iron manganese oxide, Ni_{1/3}Fe_{1/3}Mn_{1/3}, (MSE PRO, MSE Supplies, Tuscan Arizona, United States) was weighed inside of an Ar filled glovebox (Omni-Lab, California, United States). The NiFeMn was then brought out of the glovebox and placed into the carbon slurry where it was mixed a final time with the same settings.

### Spray Procedure

Strapping tape (200 m×10 mm×0.03 mm Strapping Tape, MTI, Richmond, California, United States) is placed over the top of the cell to cover the masked area of the foam. The pre cathode weight of the cell is then measured. A ⅛″ thick sheet of Delrin (McMaster-Carr, Santa Fe Springs California, United States) was laser cut (Fusion Pro, Epilog, Golden, Colorado, United States) into a 15×11 cm piece with two 12.25 cm² squares cut out of it. The cell was placed under this piece of cut Delrin before and during the spray deposition, with only the active anode material being exposed through the two cut squares. The spray atomizer (VX-70, Spraying Systems, Illinois, United States) was set up inside of a fume hood (5SA47A, Hanson Lab Solutions, Camarillo, California, United States) with compressed air for the atomizer (10 psi) and fan (7.5 psi), compressed nitrogen for raising the atomizer pin (75 psi), and the spray nozzle placed 6 inches above the cells that will be sprayed. The cathode slurry was mixed in the planetary mixer (Mazerustar KK-250S, Kurabo, Tokyo, Japan) set to a revolution setting of 7 and a rotation setting of 8 for 15 minutes. A magnetic stir bar was placed in the slurry and the slurry cup was placed on a stir plate (RT Basic Series Magnetic Stirrers, ThermoFisher Scientific, Waltham, Massachusetts, United States) that was set to 500 rpm. The slurry cup's lid was removed and a circular piece of ⅛″ Delrin with two 6 mm diameter holes was placed on top and fastened with rubber bands. Two pieces of tubing (Masterflex L/S® Precision Pump Tubing, Versilon™ 2001 Tubing, L/S 16, Avantor Sciences, Radnor, Pennsylvania, United States) were then fed into the slurry cup, with one going through the peristaltic pump (Masterflex L/S 07528-10, Avantor Sciences, Radnor, Pennsylvania, United States) before being attached to the sprayer inlet and the other going directly to the sprayer outlet. The pump was set to 25 rpm and the slurry was pumped through the sprayer. Once cathode has cycled through the entire system, the Delrin masked cells are placed underneath the sprayer and enough cathode material is deposited on the cell to achieve 25% of the anode capacity. The Delrin mask is then removed and the cells are dried at 80 °C for 30 minutes inside of a vacuum oven (VWR 1493, Avantor Sciences, Radnor, Pennsylvania, United States). The cells are then flipped upside down and placed back underneath the Delrin mask so the other side is exposed to be sprayed with cathode. The Delrin masked cells are then placed underneath the sprayer and the rest of the cathode material needed to match 25% of the anode capacity was deposited. This procedure is repeated until the desired cathode loading is achieved. The cells are then dried one last time at 80 °C for 30 minutes. Once the cells are dried, they are then calendared (FM-JS250, Felix Machines, Beaverton Oregon, United States) to a target thickness.

### E. Laminate Slurry Preparation for Sodium-Ion Batteries:

The following procedure is to make a cathode slurry that has a weight solids percentage of 51.23%, where 97.6% of the solids is NiFeMn, 2.0% Polyvinylidene Difluoride (PVDF), 0.4% Single-Walled Carbon Nanotubes (SWCNT). NiFeMn and Tuball™ Batt NMP 0.4% (Shanghai Haiyi Scientific & Trading Co., Shanghai, China) was placed into a planetary mixing cup and then mixed in the planetary mixer (Mazerustar KK-250S, Kurabo, Tokyo, Japan) set to a revolution setting of 7 and a rotation setting of 8 for 15 minutes.

### Laminate Procedure

A sheet of aluminum foil for battery cathode substrate (350 m×280 mm×15 μm, MTI, Richmond, California, United States) was cut into a 95 mm×280 mm piece that was then placed onto an automatic film applicator (TQC Sheen 1133N, Industrial Physics, Hadley, Massachusetts, United States). A square applicator (Square Frame 4″, 5-50 mils, BYK, Chester, New York, United States) was placed over the foil with 20 mil side placed on the bottom and closest to the film applicator arm. Laminate slurry was pipetted onto the foil inside of the square applicator. The film applicator was then used to push the square applicator along the aluminum foil to create a 20 mil layer of cathode slurry. The cathode foils were then dried overnight at 120 °C under vacuum. The cathode foils were placed into a laser cutter (Fusion Pro, Epilog, Golden Colorado, United States) where they we cut to match the shape of the foam cells (31 mm×31 mm) with a 13 mm×6 mm tab off one of the corners. Half of the cuts were made with the tab on the left side and half with the tab on the right. The tabs of the cathode laminates were then gently scraped to remove the cathode slurry and then cleaned by wiping with a Kimwipe and isopropanol. The cut laminates were weighed to determine the cathode capacity and then calendared (FM-JS250, Felix Machines, Beaverton Oregon, United States) to achieve a 30% porosity. Tuball™ Batt NMP (Shanghai Haiyi Scientific & Trading Co., Shanghai, China) was screen printed with an 8″×10″ stainless steel 80-mesh screen with a wire diameter of 0.0037″ (Metal Etch Service, Inc., San Marcos, California, United States) onto the cut laminates that were then adhered to both sides of the cathode sprayed anode foams, so that the laminate tabs were aligned opposite the nickel tab. These were dried under a steel plate (¼″×4″×6″) overnight at 120 °C under vacuum.

Having generally described embodiments of the invention, the following EXAMPLES demonstrate further aspects thereof.

TABLE 1
Examples 1-12 and comparative examples 1-2 of the lithium-ion cells
made as described in the procedure above with the following parameters
describing each of the individual cells: anode type, anode area, anode
mass loading normalized to area, spray coated cathode mass loading
normalized to area, laminate cathode mass loading normalized to area,
the laminate cathode mass loading versus the total cathode mass loading,
and the electrolyte. Electrolytes include LP57: 1M LiPF₆ in a 3:7 v/v
mixture of ethylene carbonate (EC) and ethyl methyl carbonate (EMC);
FEC: fluoroethylene carbonate; VC: vinylene carbonate; PC: propylene
carbonate; EC: ethylene carbonate; and DME: 1,2-dimethoxyethane (Monoglyme).
TABLE 1: The experimental parameters for EXAMPLES 1-12 and CE 1-CE 2.

| | | | | Spray | | | |
|---|---|---|---|---|---|---|---|
| | | | | coating | Laminate | Laminate | |
| | | | Anode | Cathode | Cathode | cathode | |
| | | Anode | mass per | mass per | mass per | mass vs. | |
| | Anode | area | area | area | area | total mass | |
| Example | type | cm² | mg/cm² | mg/cm² | mg/cm² | % | Electrolyte |
| 1 | Cu₂Sb | 10.5 | 82.8 | 80.7 | 87.1 | 52% | LP57 + 5% FEC |
| 2 | Cu₂Sb | 42 | 59.3 | 69.8 | 40.6 | 37% | LP57 + 5% FEC |
| 3 | Cu₂Sb | 42 | 58.3 | 81.1 | 27.3 | 25% | LP57 + 5% FEC |
| 4 | Cu₂Sb | 42 | 56.5 | 83.2 | 26.6 | 24% | LP57 + 5% FEC |
| 5 | Cu₂Sb | 10.5 | 85.7 | 96.2 | 56.6 | 37% | LP57 + 5% FEC |
| 6 | Cu₂Sb | 10.5 | 91.2 | 74.6 | 86.8 | 54% | 1M LiPF6 in PC:EC |
| | | | | | | | (1:1/wt) + 5 wt % VC |
| | | | | | | | (w.r.t. solvent) |
| 7 | Cu₂Sb | 10.5 | 61.3 | 82.4 | 13.1 | 14% | LP57 + 5% FEC |
| 8 | Cu₂Sb | 10.5 | 70.4 | 83.0 | 36.2 | 30% | LP57 + 5% FEC |
| 9 | Cu₂Sb | 10.5 | 64.1 | 74.1 | 64.4 | 46% | 1M LiPF6 in PC:EC |
| | | | | | | | (1:1/wt) + 5 wt % VC |
| | | | | | | | (w.r.t. solvent) |
| 10 | Sn | 10.5 | 36.9 | 83.6 | 56.1 | 40% | LP57 + 5% FEC |
| 11 | Sn | 10.5 | 38.5 | 67.3 | 67.0 | 50% | LP57 + 5% FEC |
| 12 | Sn | 10.5 | 36.4 | 9.1 | 107.9 | 92% | LP57 + 5% FEC |
| CE 1 | Cu₂Sb | 10.5 | 123.4 | 163 | 0 | 0% | LP57 + 5% FEC |
| CE 2 | Sn | 10.5 | 57.8 | 95.4 | 0 | 0% | LP57 + 5% FEC |

TABLE 2
The properties of the cells from examples 1-12 and comparative examples
1-2 for the lithium-ion cells described in TABLE 1, above. The properties
described include: the thickness of the unpackaged dry cell stack, the
discharge capacity normalized to area at a C/20 current rate, and the
energy density calculated according to the following equation: discharge
capacity (Ah) * time-weighted mean discharge potential (V)/volume of the
unpackaged dry cell (L).
TABLE 2:
The properties of the cells from examples 1-12 and CE 1-CE 2.

| | | Dry cell | Discharge | Energy |
|---|---|---|---|---|
| | Anode | thickness | capacity | density |
| Example | type | mm | mAh/cm² | Wh/L |
| 1 | Cu₂Sb | 1.104 | 13.7 | 352 |
| 2 | Cu₂Sb | 0.889 | 7.6 | 246 |
| 3 | Cu₂Sb | 0.976 | 8.7 | 253 |
| 4 | Cu₂Sb | 0.873 | 7.3 | 241 |
| 5 | Cu₂Sb | 1.066 | 14.1 | 383 |
| 6 | Cu₂Sb | 1.141 | 15.7 | 390 |
| 7 | Cu₂Sb | 0.788 | 7.2 | 265 |
| 8 | Cu₂Sb | 0.839 | 9.4 | 322 |
| 9 | Cu₂Sb | 0.921 | 9.7 | 293 |
| 10 | Sn | 1.044 | 18.6 | 575 |
| 11 | Sn | 0.92 | 20.5 | 728 |
| 12 | Sn | 0.793 | 10.8 | 415 |
| CE 1 | Cu₂Sb | 1.284 | 11.1 | 219 |
| CE 2 | Sn | 0.967 | 11.7 | 357 |

In Table 2, above, comparing the energy density column for copper antimonide comparative example (CE1) with copper antimonide examples, and for tin comparative example (CE2) with tin examples, the hybrid construction averages >300 Wh/L, while CE1 is 219 Wh/L for copper antimonide, and for tin, the hybrid construction averages >500 Wh/L, while CE2 is 357 Wh/L. This clearly shows the advantage of the additional cathodes in accordance with the teachings of embodiments of the present invention. Note that reference to the Comparative Examples is U.S. Pat. No. 10,290,876 for “Lithium-Ion Battery Having Interpenetrating Electrodes”, by Prieto et al., supra.

A discussion of the electrodeposition of Cu₂Sb may be found in J. AM. CHEM. SOC. 2008, 130, 10656-10661.

TABLE 3
Examples 13-16 and comparative examples 3-4 of the sodium-ion cells made
as described in the procedure above with the following parameters describing
each of the individual cells: anode type, anode area, anode mass loading
normalized to area, spray coated cathode mass loading normalized to area,
laminate cathode mass loading normalized to area, the laminate cathode
mass loading versus the total cathode mass loading, and the electrolyte.
TABLE 3: The experimental parameters for examples 13-16 and CE 3-CE 4.

| | | | | Spray | | | |
|---|---|---|---|---|---|---|---|
| | | | | coating | Laminate | Laminate | |
| | | | Anode | Cathode | Cathode | cathode | |
| | | Anode | mass per | mass per | mass per | mass vs. | |
| | Anode | area | area | area | area | total mass | |
| Example | type | cm² | mg/cm² | mg/cm² | mg/cm² | % | Electrolyte |
| 13 | Sn | 10.5 | 50.1 | 69.0 | 54.1 | 44% | 1M NaClO₄ in 95/5 |
| | | | | | | | DME:FEC |
| 14 | Sn | 10.5 | 48.6 | 70.5 | 54.8 | 44% | 1M NaClO₄ in 95/5 |
| | | | | | | | DME:FEC |
| 15 | Sn | 10.5 | 49.1 | 72.2 | 53.7 | 43% | 1M NaClO₄ in 95/5 |
| | | | | | | | DME:FEC |
| 16 | Sn | 10.5 | 48.0 | 72.5 | 54.1 | 43% | 1M NaClO₄ in 95/5 |
| | | | | | | | DME:FEC |
| CE 3 | Sn | 10.5 | 59.9 | 212 | 0 | 0% | 1.2M NaPF₆ in DME |
| CE 4 | Cu₂Sb | 10.5 | 103 | 169 | 0 | 0% | 1M NaPF₆ in 2/1 |
| | | | | | | | PC:DME, 5% FEC |

TABLE 4
The properties of the cells from examples 13-16 and comparative examples
3-4 for the sodium-ion cells described in table 3. The properties
described include: the thickness of the unpackaged dry cell stack, the
discharge capacity normalized to area at a C/20 current rate, and the
energy density calculated according to the following equation: discharge
capacity (Ah) * time-weighted mean discharge potential (V)/volume of the
unpackaged dry cell (L).
TABLE 4:
The properties of the cells from examples 13-16 and CE 3-CE 4.

| | | Dry cell | Discharge | Energy |
|---|---|---|---|---|
| | Anode | thickness | capacity | density |
| Example | type | mm | mAh/cm² | Wh/L |
| 13 | Sn | 1.157 | 11.3 | 267 |
| 14 | Sn | 1.075 | 11.4 | 294 |
| 15 | Sn | 1.081 | 10.4 | 269 |
| 16 | Sn | 1.095 | 9.5 | 231 |
| CE 3 | Sn | 2.555 | 11.1 | 125 |
| CE 4 | Cu₂Sb | 2.200 | 8.1 | 78 |

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the Statements Of The Invention appended hereto.

What is claimed is:

1. A Li-Ion battery, comprising: a 3-dimensional porous anode current collector having an intermetallic composition or tin electrodeposited thereon for reversibly alloying lithium ions, and a lithium-ion, conducting, electrically insulating, gelled polymer electrolyte covering the intermetallic or tin; a first cathode material deposited on said electrolyte interpenetrating the porous spaces of the 3-dimensional porous anode current collector, forming a 3-dimensional flat structure having a first surface and an opposing second surface; a first electrically conductive layer in electrical communication with the first cathode material and covering the first surface; a second electrically conductive layer in electrical communication with the first cathode material and covering the second surface; a first layer of second cathode material coated onto a first metal current collector and in electrical contact with the first electrically conductive layer; and a second layer of second cathode material coated onto a second metal current collector and in electrical contact with the second electrically conductive layer.

2. The Li-Ion battery of claim 1, wherein the first layer of second cathode material and the second layer of second cathode material are flat.

3. The Li-Ion battery of claim 1, wherein said first cathode material comprises: LiNi_{0.8}Co_{0.1}Mn_{0.1}O₂, conductive carbon, graphite, and Polyvinylidene Difluoride.

4. The Li-Ion battery of claim 1, wherein said second cathode material comprises: LiNi_{0.8}Co_{0.1}Mn_{0.1}O₂, carbon nanotubes, and Polyvinylidene Difluoride.

5. The Li-Ion battery of claim 1, wherein the first metal current collector and the second current collector comprise aluminum foil current collectors.

6. A Na-Ion battery, comprising: a 3-dimensional porous anode current collector having an intermetallic composition or tin electrodeposited thereon for reversibly alloying sodium ions, and a sodium-ion, conducting, electrically insulating, gelled polymer electrolyte covering the intermetallic or tin; a first cathode material deposited on said electrolyte interpenetrating the porous spaces of the 3-dimensional porous anode current collector, forming a 3-dimensional flat structure having a first surface and an opposing second surface; a first electrically conductive layer in electrical communication with the first cathode material and covering the first surface; a second electrically conductive layer in electrical communication with the first cathode material and covering the second surface; a flat first layer of second cathode material coated onto a first metal current collector and in electrical contact with the first electrically conductive layer; and a flat second layer of second cathode material coated onto a second metal current collector and in electrical contact with the second electrically conductive layer.

7. The Na-Ion battery of claim 6, wherein the first layer of second cathode material and the second layer of second cathode material are flat.

8. The Na-Ion battery of claim 6, wherein said first cathode material comprises: NaNi_{1/3}Fe_{1/3}Mn_{1/3}O₂, conductive carbon, graphite, and Polyvinylidene Difluoride.

9. The Na-Ion battery of claim 6, wherein said second cathode material comprises: NaNi_{1/3}Fe_{1/3}Mn_{1/3}O₂, carbon nanotubes, and Polyvinylidene Difluoride.

10. The Na-Ion battery of claim 6, wherein the first metal current collector and the second current collector comprise aluminum foil current collectors.
